(19) United States
(12) Patent Application Publication
(10) Pub. No.: US 2017/0221152 A1
(43) Pub. Date: Aug. 3, 2017

(54) WATER DAMAGE MITIGATION ESTIMATING SYSTEM AND METHOD

(71) Applicant: Loss Technology Services, Inc., Jacksonville, FL (US)

(72) Inventors: Edwin Ted NELSON, Jacksonville, FL (US); Warren D. ERICKSON, Gainesville, GA (US)

(21) Appl. No.: 15/423,392

(22) Filed: Feb. 2, 2017

Related U.S. Application Data
(60) Provisional application No. 62/290,401, filed on Feb. 2, 2016.

(51) Int. Cl. G06Q 40/08; G06Q 50/16; G06Q 30/02

(52) U.S. Cl. CPC G06Q 40/08; G06Q 30/0278; G06Q 50/16

(57) ABSTRACT

A water damage mitigation estimation method accepts insurance claim information regarding a water damage insurance claim. The insurance claim information includes a date-of-loss, an insurance-company, insured-information, and a price-book-to-use. The method also accepts structure information regarding the water damage insurance claim. The structure information including square-footage, year-built, central-air-conditioning, foundation-type, construction-type, and number-of-floors. The method accepts loss information regarding the water damage insurance claim, and the loss information includes water-source, anti-microbial, source-location, time-water-stopped, time-respondent-on-site, emergency-time, and affected-area. The method accepts a set of room-information for each water damaged room, each member of the set of room-information includes floor-level, room-dimensions, offset-inset, percent-affected, material-type, and detectable-water-affect. The method then generates a water damage mitigation estimate to mitigate water damage associated with the water damage insurance claim. The water damage mitigation estimate includes information related to a scope of work for mitigating the water damage, including, equipment-to-mitigate, time-to-mitigate, and price-to-mitigate.

### BACKGROUND

Technical Field

The present disclosure generally relates to water damage insurance claims. More particularly, but not exclusively, the present disclosure relates to a water damage mitigation estimating tool to generate actionable information associated with a water damaged property.

Description of the Related Art

Currently, insurance water claims occur over 2 million times per year resulting in $10.5 billion in payouts. This does not count claims that are either not covered or not reported but still are in need of professional restoration. It is also one of the only insurance related loss types that are not estimated nor paid until after the work is complete.

The restoration industry has standards and formulas dictating what equipment should be used in given scenarios and several applications exist to track and monitor the moisture drying process according to those standards. Upon completion of a water damage mitigation event, an invoice is compiled by the contractor and submitted to the homeowner and their insurance company. Typical time from job start to paid invoice is 30 days or more.

In all or nearly all other areas of insurance property claims, a scope and estimate is produced and negotiated before the work is started or completed. It is more difficult to resolve an invoice after the work has been completed than it is to negotiate an estimate beforehand. The after-the-fact resolution requires additional time spent by many parties and results in a large number of controversial invoices.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

In one or more embodiments, the present disclosure provides a method that includes: receiving, by a water damage mitigation estimation application hosted at least partially on a server computer device, insurance claim information regarding a water damaged property, the insurance claim information including information indicating a date of loss, an insurance company and insured information; receiving, by the water damage mitigation estimation application, structure information regarding the water damaged property, the structure information including information indicating a square footage of the property, a year the property was built, whether the property includes operable air conditioning, a foundation type of the property, a construction type of the property, and a number of floors of the property; receiving, by the water damage mitigation estimation application, loss information regarding the water damaged property, the loss information including information indicating a water source associated with the water damage, a location of the water source, a time the water source stopped, a time a water damage mitigator arrived on-site at the property, and a number of floors affected by the water damage; receiving, by the water damage mitigation estimation application, a set of room information for each water damaged room in the property, each member of the set of room information including information indicating a floor level, dimensions, a percent of flooring affected by the water damage, a percent of walls affected by the water damage, a percent of a ceiling affected by the water damage, a floor material type, whether a baseboard will be removed, whether wet drywall will be removed and whether there are contents; generating, by the water damage mitigation estimation application, an insurance claim estimate to mitigate the water damage, the insurance claim estimate including equipment-to-mitigate, time-to-mitigate, labor-to-mitigate (including, for example, monitoring, set up and take down, specific tasks required, and so on) and price-to-mitigate, the insurance claim estimate being generated based on the received structure information, loss information and set of room information; and outputting the generated insurance claim estimate to mitigate the water damage.

In another embodiment, the present disclosure provides a water damage mitigation estimation system. The system includes a first computing device, a water damage mitigation estimate database arranged to store electronic water damage mitigation estimates associated with respective water damaged structures, and a water damage mitigation estimation application that is stored at least partially on a second computing device having a processor. The water damage mitigation estimation application has access to a pricing database, a task and equipment database, an insurance database, a map and image database, a property database and a rules database. The water damage mitigation estimation application is configured to: receive insurance claim information regarding a water damaged property, the insurance claim information including information indicating a date of loss, an insurance company and insured information, the insurance claim information being received from at least one of the first computer device and the insurance database; receive structure information regarding the water damaged property, the structure information including information indicating a square footage of the property, a year the property was built, whether the property includes operable air conditioning, a foundation type of the property, a construction type of the property, and a number of floors of the property, the structure information being received from at least one of the first computer device and the property database; receive loss information regarding the water damaged property, the loss information including information indicating a water source associated with the water damage, a location of the water source, a time the water source stopped, a time a water damage mitigator arrived on-site at the property, and a number of floors affected by the water damage, the loss information being received from the first computer device; receive a set of room information for each water damaged room in the property, each member of the set of room information including information indicating a floor level, dimensions, a percent of flooring affected by the water damage, a percent of walls affected by the water damage, a percent of a ceiling affected by the water damage, a floor material type, whether a baseboard will be removed, whether wet drywall will be removed and whether there are contents, the set of room information being received from the first computer device; generating an insurance claim estimate to mitigate the water damage, the insurance claim estimate including equipment-to-mitigate, time-to-mitigate, labor-to-mitigate (including, for example, monitoring, set up and take down, specific tasks required, and so on) and price-to-mitigate, the insurance claim estimate being generated based on the received structure information, loss information and set of room information, the insurance claim estimate being generated based on the received insurance claim information, structure information, loss information, set of room information and rules stored in the rules database; and output the generated insurance claim estimate to mitigate the water damage.

In yet another embodiment, the present disclosure provides a non-transitory computer program product having stored thereon a set of computer instructions, the computer instructions configured to carry out a method comprising: receiving, by a water damage mitigation estimation application hosted at least partially on a server computer device, insurance claim information regarding a water damaged property, the insurance claim information including information indicating a date of loss, an insurance company and insured information; receiving, by the water damage mitigation estimation application, structure information regarding the water damaged property, the structure information including information indicating a square footage of the property, a year the property was built, whether the property includes operable air conditioning, a foundation type of the property, a construction type of the property, and a number of floors of the property; receiving, by the water damage mitigation estimation application, loss information regarding the water damaged property, the loss information including information indicating a water source associated with the water damage, a location of the water source, a time the water source stopped, a time a water damage mitigator arrived on-site at the property, and a number of floors affected by the water damage; receiving, by the water damage mitigation estimation application, a set of room information for each water damaged room in the property, each member of the set of room information including information indicating a floor level, dimensions, a percent of flooring affected by the water damage, a percent of walls affected by the water damage, a percent of a ceiling affected by the water damage, a floor material type, whether a baseboard will be removed, whether wet drywall will be removed and whether there are contents; generating, by the water damage mitigation estimation application, an insurance claim estimate to mitigate the water damage, the insurance claim estimate including equipment-to-mitigate, time-to-mitigate, labor-to-mitigate (including, for example, monitoring, set up and take down, specific tasks required, and so on) and price-to-mitigate, the insurance claim estimate being generated based on the received structure information, loss information and set of room information; and outputting the generated insurance claim estimate to mitigate the water damage.

This Brief Summary has been provided to introduce certain concepts in a simplified form that are further described in detail below in the Detailed Description. Except where otherwise expressly stated, the summary is not intended to identify key or essential features of the claimed subject matter, nor is it intended to limit the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The particular shapes of the elements as drawn have been selected for ease of recognition in the drawings. One or more embodiments are described hereinafter with reference to the accompanying drawings in which:

FIG. 1 is a block diagram of a water damage mitigation estimation system, in accordance with one or more embodiments of the disclosure;

FIG. 2A is a block diagram illustrating further details of the machine learning engine in the water damage mitigation estimation system of FIG. 1, in accordance with one or more embodiments of the disclosure;

FIG. 2B is a flowchart illustrating a water damage mitigation estimate production method, in accordance with one or more embodiments of the disclosure; and

FIGS. 3 through 8 illustrate webpages provided by the water damage mitigation estimation system, and further illustrate the water damage mitigation estimate production method in conjunction with FIG. 2B.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks have not been shown or described in detail to avoid unnecessarily obscuring descriptions of the embodiments.

The present invention may be understood more readily by reference to the following detailed description of the preferred embodiments of the invention. It is to be understood that the terminology used herein is for the purpose of describing specific embodiments only and is not intended to be limiting. It is further to be understood that unless specifically defined herein, the terminology used herein is to be given its traditional meaning as known in the relevant art.

The IICRC, Institute of Inspection Cleaning and Restoration Certification, is an American National Standard Institute (ANSI) member and accredited standards developer. The IICRC published ANSI standard IICRC 5500 in 2006. The latest ANSI/IICRC S500-2015 was released in December of 2015. These documents describe in principles of Water Damage Restoration, Building and Material Sciences, Equipment Usage, Psychrometry and Drying Technology, as well as Safety and Health issues. Mitigation contractors are left to their own abilities to apply the IICRC 5500 information in the field to hundreds of various situations and determine a “drying plan” along with an invoice at the conclusion. Similar to the IICRC standards, the National Flood Insurance Program (NFIP), which is a part of the Federal Emergency Management Agency (FEMA), provides guidelines and/or standards associated with claims and coverage for flood-related water damage, which are specifically outlined in FEMA Bulletin W-13025a.

The computer application and methods disclosed herein incorporate, in a computing device, such as a cloud-based device, a mobile device, or some other computing device, a solution to determine equipment and task needs to mitigate a water damage event based on specific job attributes at the water damaged site, scientific formulas, and published industry standards. The present disclosure describes one or more tools employed to derive a detailed scope of acts a water damage mitigator should carry out in one or more time periods following the water damage occurrence. Utilizing one or more industry-acceptable pricing databases, for example a pricing database selected by the insurance carrier, via an XML feed for example, an estimate of total priced restoration is generated. The estimate and the detailed actions and implements used to carry out the water damage mitigation actions can be agreed to, argued, or otherwise negotiated with confidence on the initial visit by the water mitigator. It has been discovered that the tools and methods discussed herein may cut the time from loss to claim payment by 30 days or more, which may result in many millions of dollars in savings by the gained efficiency.

Thousands of past water damage claims have been reviewed and studied to isolate key elements that determine Category and Class of each water damage event. Complex algorithms have been developed and compiled, each having a large number of variations and affected by existing construction materials in the home, age of construction, location of damage, and other factors. A water damage mitigation estimation tool was then developed to dynamically apply the features of the present disclosure according to each loss scenario in a concrete and tangible way that cannot be performed manually.

In the present disclosure one or more embodiments may include particular data flow diagrams illustrating non-limiting processes that may be used by the water damage mitigation estimation tool embodiments. In this regard, each described process may represent a module, segment, or portion of software code, which comprises one or more executable instructions for implementing the specified logical function(s). It should also be noted that in some implementations, the functions noted in the process may occur in a different order, may include additional functions, may occur concurrently, and/or may be omitted.

The figures in the present disclosure illustrate portions of one or more non-limiting computing device embodiments. The computing devices may include operative hardware found in conventional computing device apparatuses such as one or more processors, volatile and non-volatile memory, serial and parallel input/output (I/O) circuitry compliant with various standards and protocols, wired and/or wireless networking circuitry (e.g., a communications transceiver), one or more user interface (UI) modules, logic, and other electronic circuitry.

Processors, as described herein, include central processing units (CPU's), microcontrollers (MCU), digital signal processors (DSP), application specific integrated circuits (ASIC), and the like. The processors interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, embodiments describe software executable by the processor and operable to execute certain ones of the method acts.

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to be executed by a processor.

The computing devices illustrated herein may further include operative software found in a conventional computing device such as an operating system or task loop, software drivers to direct operations through I/O circuitry, networking circuitry, and other peripheral component circuitry. In addition, the computing devices may include operative application software such as network software for communicating with other computing devices, database software for building and maintaining databases, and task management software where appropriate for distributing the communication and/or operational workload amongst various processors. In some cases, the computing device is a single hardware machine having at least some of the hardware and software listed herein, and in other cases, the computing device is a networked collection of hardware and software machines working together in a server farm to execute the functions of one or more embodiments described herein. Some aspects of the conventional hardware and software of the computing device are not shown in the figures for simplicity.

When so arranged as described herein, each computing device may be transformed from a generic and unspecific computing device to a combination device comprising hardware and software configured for a specific and particular purpose. For example, embodiments in the present disclosure comprise hardware and software configured to provide acts of a water damage mitigation estimation tool that improves the efficiency, timing, costs, and effectiveness of water damage insurance claims. Other benefits of the water damage mitigation estimation tool are also recognized, and said benefits are expressly provided by the hardware and software configured for this specific and particular purpose.

Database structures, if any are present in the water damage mitigation estimation tool, may be formed in a single database or multiple databases. In some cases hardware or software storage repositories are shared amongst various functions of the particular system or systems to which they are associated. A database may be formed as part of a local system or local area network. Alternatively, or in addition, a database may be formed remotely, such as within a “cloud” computing system, which would be accessible via a wide area network or some other network.

Input/output (I/O) circuitry and user interface (UI) modules include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

In at least one embodiment, devices such as a control system may communicate with other devices via communication over a network. The network may involve an Internet connection or some other type of local area network (LAN) or wide area network (WAN). Non-limiting examples of structures that enable or form parts of a network include, but are not limited to, an Ethernet, twisted pair Ethernet, digital subscriber loop (DSL) devices, wireless LAN, WiFi, Worldwide Interoperability for Microwave Access (WiMax), or the like.

In some cases, the memory described herein is a non-transitory computer readable medium (CRM). The CRM is configured to store computing instructions executable by a CPU of a control system. The computing instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of a water damage mitigation estimation tool.

Buttons, keypads, computer mice, memory cards, serial ports, bio-sensor readers, touch screens, and the like may individually or in cooperation be useful to an operator of the water damage mitigation estimation tool. The devices may, for example, input control information into the system. Displays, printers, memory cards, LED indicators, temperature sensors, audio devices (e.g., speakers, piezo device, etc.), vibrators, and the like are all useful to present output information to the operator of the water damage mitigation estimation tool. In some cases, the input and output devices are directly coupled to a control system and electronically coupled to a CPU or other operative circuitry. In other cases, the input and output devices pass information via one or more communication ports (e.g., RS-232, RS-485, infrared, USB, etc.)

As described herein, for simplicity, water damage mitigator may in some cases be described in the context of the male gender. It is understood that a water damage mitigator can be of any gender, and the terms “he,” “his,” and the like as used herein are to be interpreted broadly inclusive of all known gender definitions.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, the technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks, have not been shown or described in detail to avoid unnecessarily obscuring descriptions of the embodiments.

Certain words and phrases used in the present disclosure are set forth as follows. The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this patent document. Those of ordinary skill in the art will understand that in many, if not most instances, such definitions apply to prior as well as future uses of such defined words and phrases.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

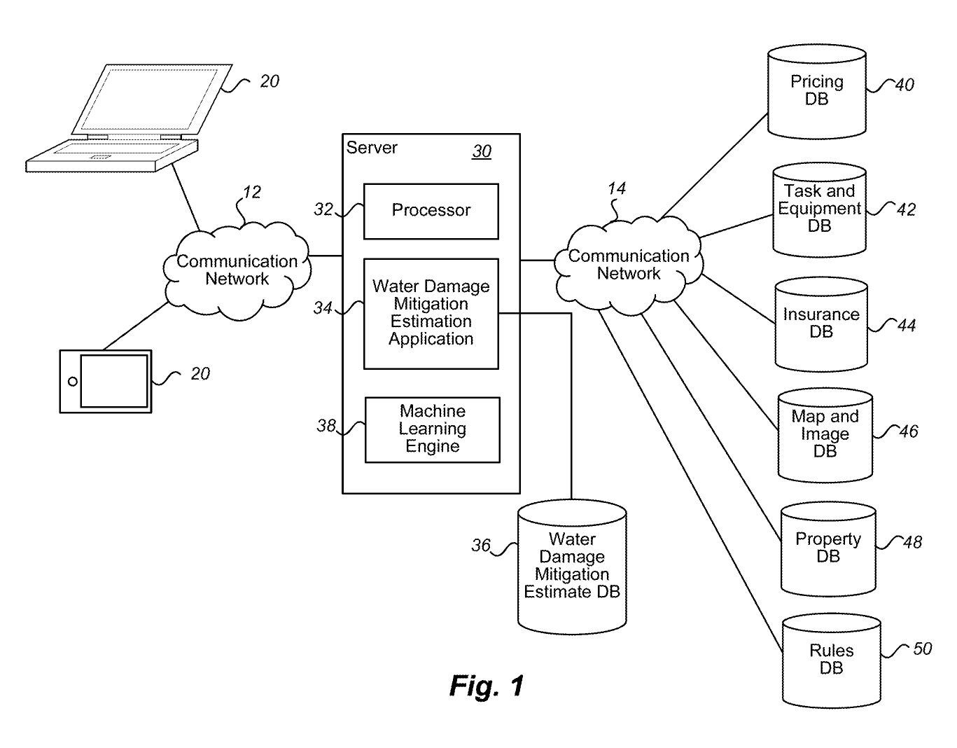

FIG. 1 is a block diagram illustrating a water damage mitigation estimation system 10 (referred to hereinafter as “system 10”) in accordance with embodiments of the present disclosure. As shown in FIG. 1, the system 10 includes a water damage mitigation estimation application 34, one or more communication networks 12, 14, one or more user computer devices 20, and a water damage mitigation estimate database 36. The system 10 may further include a pricing database 40, a task and equipment database 42, an insurance database 44, a map and image database 46, a property database 48, and a rules database 50.

A user computer device 20 is a computing device capable of communicating with, participating with, controlling, directing or being directed by, or otherwise accessing the water damage mitigation estimation application 34 via a communications network 12, 14. The user computer device 20 may be, for example, a personal computer, a tablet computer, a smartphone, or the like.

Communications networks 12, 14 may utilize one or more protocols to communicate via one or more physical networks, including local area networks, wireless networks, dedicated communication lines, intranets, the Internet, and the like.

The water damage mitigation estimation application 34 is stored at least partially on a server computer device 30. In one or more embodiments, the water damage mitigation estimation application 34 may be a cloud-based or otherwise distributed computing application that is stored on, executed from, or otherwise deployed via one or more server computer devices. The server computer device 30 includes a processor 32, and the water damage mitigation estimation application 34 may be stored in any computer-readable storage medium.

The processor 32 may be any one or more computing processor devices operable to execute software instructions stored in a memory to perform the functions of the water damage mitigation estimation application 34 described herein.

The pricing database 40 is an industry-acceptable pricing database as described herein. The pricing database 40 may be one or more databases arranged to store and provide information associating pricing information with various items that may be related to a water mitigation job or project, such as costs for labor, equipment, debris removal, and the like. The pricing database 40 may be a searchable database. The pricing database 40 may be or include one or more private or public databases, and may include pricing information provided, managed, maintained or otherwise administered by a variety of sources (e.g., an insurance company, contractor, or other entity's pricing databases). In one or more embodiments, the pricing database 40 may store “price book” information from multiple sources, each having independent pricing information for various tasks, equipment or the like. The water damage mitigation estimation application 34 may thus utilize one or more of the price books, as desired and/or determined by the system 10. In one or more embodiments, the system 10 allows for manual input of custom pricing information for specific items that are included in the generated water damage mitigation estimate.

The task and equipment database 42 may be one or more databases arranged to store and provide task and/or equipment information associated with water damage mitigation. The task and equipment information stored in the task and equipment database 42 includes, for example, water mitigation task information (e.g., cleaning, water extraction, applying anti-microbial, debris removal, drywall removal and replacement, drying tasks, baseboard removal, etc.) and equipment information for performing the water mitigation tasks (e.g., make, model, capacity, and other such information associated with equipment such as dehumidifiers, air filtration devices or scrubbers, desiccants, air movers, wall cavity dryers, floor drying systems, heat drying systems, and the like). The task and equipment database 42 may be a searchable database.

The insurance database 44 may be one or more databases arranged to store and provide insurance information associated with water damage mitigation claims. The insurance database 44 may be a searchable database. The insurance database 44 may be or include one or more private or public databases and may include insurance data managed, maintained or otherwise administered by a variety of sources, such as one or more insurance companies. For example, the insurance database 44 may include insurance information relating to an insured's property that has experienced water damage, including, for example, the insured's name, address, policy number, date of loss, the insurance company, claim number, adjuster name and so on. The insurance information stored in the insurance database 44 may be provided by the insurance companies and accessible to the water damage mitigation estimation application 34 (e.g., for generation of a water damage mitigation estimate), or may be provided through user input (e.g., a user of a computer device 20) for generating a water damage mitigation estimate.

The map and image database 46 may be one or more databases arranged to store and provide map and/or image information associated with real property structures such as homes, buildings and the like. The map and image database 46 may be a searchable database (e.g., by entering a particular address or geocoding information, the database may output map and/or image information associated with the address or geocoding information). The map and image database 46 may be or include one or more private or public databases and may include image information provided, managed, maintained or otherwise administered by a variety of sources. For example, the map and image database 46 may be or include information provided by GOOGLE MAPS, or the like.

The property database 48 may be one or more databases arranged to store and provide information related to properties, such as homes, buildings and the like. The property database 48 may be or include one or more private or public databases and may include image information provided, managed, maintained or otherwise administered by a variety of sources. For example, the property database 48 may contain publicly-available information (e.g., the square footage of a home, when the home was built, how many floors, whether there is a basement, whether the home has air conditioning, foundation type, construction type, etc.), as may be obtained from governmental entities or departments (such as building departments, tax records, real estate data, etc.).

The rules database 50 may be one or more databases arranged to store and provide rules information for determining and generating various items included in a water damage mitigation estimate. The rules database 50 may be a searchable and configurable database, such that the rules may be updated or otherwise edited by an authorized user (i.e., a user having permission to edit rules) of the system 10. The rules database 50 contains rules for determining and generating the items included in a water damage mitigation estimate, in terms of both “flood loss” rules (e.g., rules to be utilized by the water damage mitigation estimation application 34 for generating a water damage mitigation estimate due to water damage caused by flooding which is to be insured under a flood insurance policy) and property and casualty (P&C) rules (e.g., rules to be utilized by the water damage mitigation estimation application 34 for generating a water damage mitigation estimate due to non-flood related water damage that is to be covered under a P&C insurance policy). Every task item (e.g., as stored in the task and equipment database 42) that may be included or otherwise used in a water damage mitigation estimate is associated with both a flood loss rule and a P&C rule, as the cause and source of loss affects how the claim will be treated by the system 10 (e.g., in the generated water damage mitigation estimate). Flood loss rules may be based, for example, on FEMA guidelines (e.g., as specifically outlined in FEMA Bulletin W-13025a) for the mitigation of water damage caused by flooding.

The water damage mitigation estimate database 36 is arranged to store and provide electronic water damage mitigation estimates associated with real property structures. The water damage mitigation estimates stored, generated, produced, or otherwise utilized in the system 10 may be fully completed estimates or partially completed estimates (e.g., an estimate not yet completed, but saved in the database 36 so that it may be later retrieved by a user and completed). As will be discussed in further detail herein, the water damage mitigation estimates are generated by the water damage mitigation estimation application 34, based on information provided by a user (e.g., through a webpage or similar interface provided by the water damage mitigation estimation application 34) and on information stored in the pricing database 40, the task and equipment database 42, the insurance database 44, the map and image database 46, the property database 48 and the rules database 50.

The water damage mitigation estimation system 10 allows a user of a user computer device 20 (e.g., a claims estimator, claims administrator, claims adjustor, water damage mitigation contractor, etc.) to access the water damage mitigation estimation application 34, e.g., via the communication network 12. The water damage mitigation estimation application 34 may include or otherwise provide a graphical user interface to the user (e.g., a webpage or similar access portal) through which the user may input data, view results (e.g., completed or partially completed water damage mitigation claims), or otherwise communicate with or access the functionality of the water damage mitigation application 34. The water damage mitigation estimates produced by the system 10 include cost estimates and tasks to be completed (e.g., drying of walls, dehumidifying rooms or areas in the home, water extraction from floors, and so on) for mitigating the water damage. As such, the water damage mitigation estimate is a report indicating the tasks to be performed, the equipment to perform those tasks, the costs for each task or line item in the generated estimate, and the total costs associated with the water mitigation project. Additionally, the system 10 produces water damage mitigation estimates that provide an acceptably optimized or otherwise acceptable best-fit water mitigation solution under the particular circumstances, based on algorithms and/or rules performed or applied by the water damage mitigation estimation application 34.

The water damage mitigation estimation system 10 may further include a machine learning engine 38 that is communicatively coupled to the water damage mitigation estimation application 34 and to the rules database 50. The machine learning engine 38 may further be coupled to one or more of the pricing database 40, the task and equipment database, the insurance database 44, the map and image database 46 and/or the property database 48.

The machine learning engine 38 receives information provided as input (e.g., by a user) to the water damage mitigation estimation application 34, and further receives water damage mitigation estimates produced based on such input (as well as on the rules stored in the rules database 50), and refines the algorithms or rules implemented by the system 10 based on training data provided to the machine learning engine 38. The training data may be, for example, corrections or adjustments made to a generated water damage mitigation estimate, which are notated and stored in the water damage mitigation estimate database 36. The corrections (e.g., an adjustment made to an estimated drying time, cost, equipment, etc.) may be interpreted by the machine learning engine 38 as input data, and the algorithms or rules utilized by the water damage mitigation estimation application 34 (some which may be stored in the rules database 50) may be updated, adjusted or refined by the machine learning engine 38 to account for such corrections. The machine learning engine 38 may implement computationally intelligent systems and methods to learn “knowledge” (e.g., based on training data), and use such learned knowledge to adapt its approaches for solving one or more problems (e.g., by adjusting algorithms and/or rules utilized by the water damage mitigation estimation application 34 to generate an appropriate and/or determined optimal water damage mitigation estimate). The machine learning engine 38 may employ, for example, neural network, deep learning, convolutional neural network, and Bayesian program learning techniques to update, adjust or refine the algorithms and/or rules utilized by the water damage mitigation estimation application 34. Further, the machine learning engine 38 may employ any one or combination of the following computational techniques: constraint program, fuzzy logic, classification, conventional artificial intelligence, symbolic manipulation, fuzzy set theory, evolutionary computation, cybernetics, data mining, approximate reasoning, derivative-free optimization, decision trees, and/or soft computing.

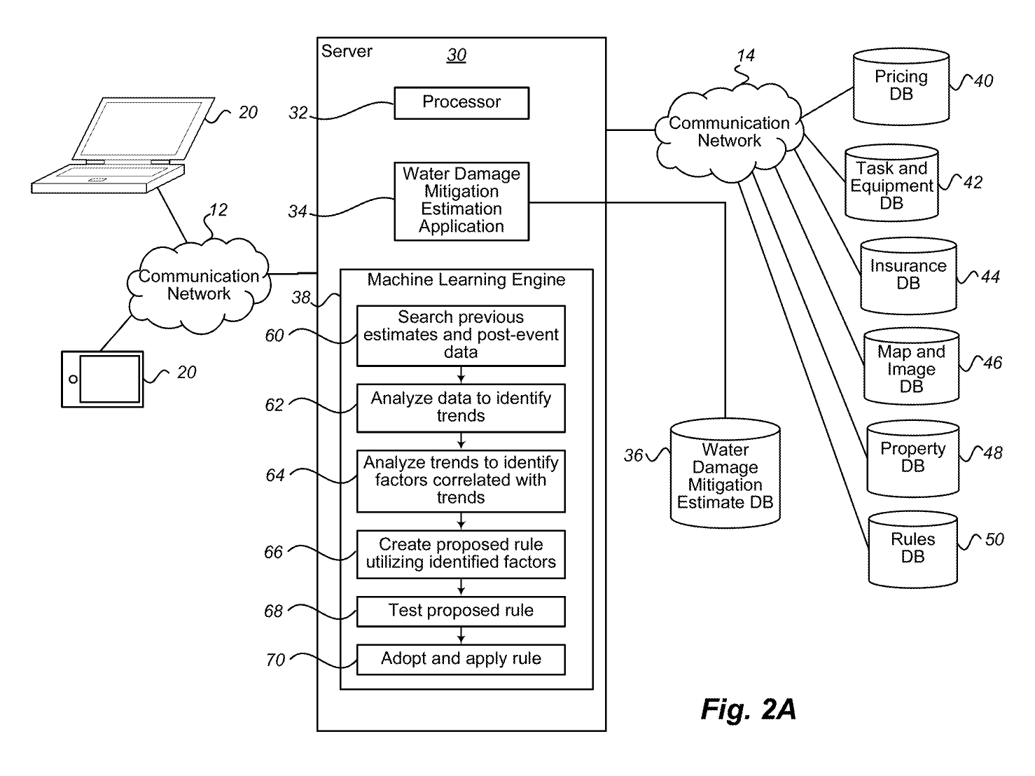

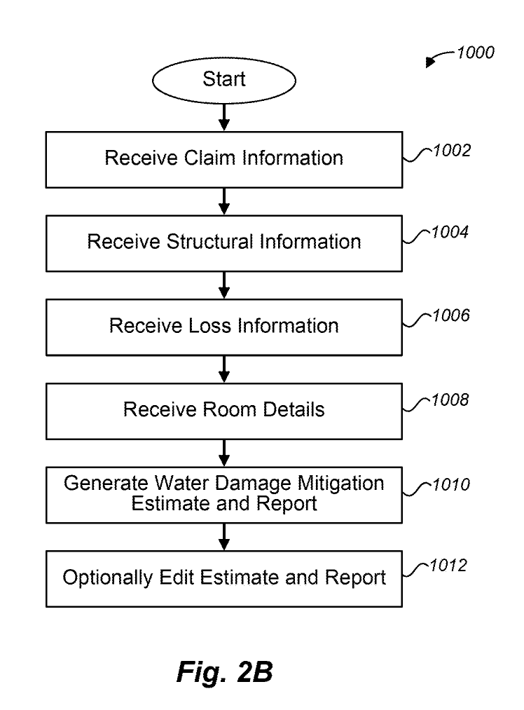

FIG. 2A is a block diagram illustrating further details of the machine learning engine 38 in the water damage mitigation estimation system 10 of FIG. 1, and in particular, illustrates a method performed by the machine learning engine 38 to create, test and implement new or modified rules utilized by the water damage mitigation estimation application 34 for generating water damage mitigation estimates. The machine learning engine 38 is coupled to the water damage mitigation estimation application 34, the water damage mitigation estimate database 36 and further may be coupled to the pricing database 40, the task and equipment database, the insurance database 44, the map and image database 46, the property database 48 and the rules database 50.

In an exemplary embodiment, as shown at module 60, the machine learning engine 38 automatically searches previous water damage mitigation estimates (e.g., as stored in the water damage mitigation estimate database 36) and post-event actual data (e.g., an actual invoiced amount for the water damage mitigation services performed, a settlement amount, the equipment and time such equipment was actually used to mitigate the water damage, and the like).

At module 62, the machine learning engine 38 analyzes the previous estimates and post-event actual data to identify one or more water damage mitigation trends. The water damage mitigation trends may be identified on the basis of any input data and/or any items included in a generated water damage mitigation estimate, as well as on any correlations between such data (e.g., date of loss may be identified as being correlated with factors such as local weather conditions which may impact the water damage mitigation solution).

As one example, the machine learning engine 38 mines and analyzes the data included in the water damage mitigation estimate database 36 (including both the generated estimates and information associated with the actual completion of the water damage mitigation effort) to identify trends such as that drying a ground-floor or basement-level room took longer than estimated for properties within a particular geographic area (e.g., a zip code).

Once the machine learning engine 38 has identified a trend in the water damage mitigation estimates, the machine learning engine 38 further analyzes the trend to identify one or more factors correlated with the identified trend, as shown at module 64. The machine learning engine 38 may access any of the databases (e.g., databases 40, 42, 44, 46, 48 and 50) in the system 10, as well as other public and/or private databases that may be available (e.g., a weather database containing historical, current and/or predicted weather information for a variety of geographic areas) in order to identify potential causes or factors that are correlated with the identified trend. In an example, the machine learning engine 38 automatically retrieves weather data from a publicly-available weather database, and analyzes the weather data to identify the weather conditions (e.g., high humidity, rain, etc.) as being correlated with the identified trend (e.g., drying a ground-floor or basement-level room took longer than estimated for water damaged properties within a particular zip code during a particularly wet or humid day, week, month, etc.).

At module 66, the machine learning engine 38 then creates a proposed new rule to account for the correlation between the identified factors and the identified trend. The proposed new rule may be a modification to an existing rule (e.g. as stored in the rules database 50) or may be an entirely new rule created by the machine learning engine 38, then stored in the rules database 50 and utilized by the system 10 for generating new and/or updating existing water damage mitigation estimates.

For example, weather conditions such as precipitation, humidity, temperature and the like may already be included in the rules database 50 as factors for determining a drying time, drying equipment to use, etc. for a water damaged property. As such, the machine learning engine 38 creates a proposed modification to the existing rule to better account for the impact that the actual weather conditions had on the water damage mitigation solution (i.e., to better account for the identified trend that drying a ground-floor or basement-level room took longer than estimated for water damaged properties within a particular zip code during particular, identifiable weather conditions). The proposed modified rule created by the machine learning engine 38 may thus include an adjustment to a weighting or scaling factor associated with weather conditions (e.g., precipitation, humidity, temperature, or the like), such that the actual water damage mitigation solution (e.g., an actual amount of time to dry a ground-floor or basement-level room within the particular zip code during a particular time period) better matches with water damage mitigation estimates produced using the modified rule.

In another example, the machine learning engine 38 may create, as the proposed new rule, an entirely new rule to account for the correlation between the identified factors and the identified trend. For example, after the machine learning engine 38 has determined a correlation between weather conditions and the identified trend (e.g., that drying times took longer than originally estimated for ground-floor or basement-level rooms within the particular zip code during a particular time period), the machine learning engine 38 may create a proposed new rule that includes weather conditions as a factor in determining drying times for ground-floor or basement-level rooms, and that applies a suitable weighting or scaling factor to weather conditions in the new rule in order to better match the actual water damage mitigation solutions with water damage mitigation estimates produced using the new rule.

The proposed new (or modified) rule is then tested by the machine learning engine 38, as shown at module 68, to determine the accuracy of the rule. The machine learning engine 38 may test the proposed new rule by applying the new rule to hundreds, thousands, or more, of previous water damage mitigation estimates (and actual water damage mitigation solution data, which may be included in the water damage mitigation estimates). For example, the machine learning engine 38 may access numerous water damage mitigation estimates stored in the water damage mitigation estimate database 36, and generate new estimates based on the proposed new rule. The water damage mitigation estimates that are tested with the new rule may include estimates that were produced for properties in various different geographical areas (e.g., in different zip codes) and for which various weather conditions were experienced at the time of the water damage mitigation activities (e.g., various weather conditions were present while drying ground-floor or basement-level rooms). The new, test estimates are then compared, by the machine learning engine 38, to the original estimates and analyzed to determine whether the new rule improves the water damage mitigation estimates produced by the system 10. The machine learning engine 38 may modify the proposed new rule based on the testing, and may re-run tests until the machine learning engine 38 has determined a new rule that suitably or best accounts for the correlation between the identified factors (e.g., weather conditions) and the identified trend (e.g., drying times) across all of the test data.

Once this has been completed, the machine learning engine 38 may adopt the proposed new rule as a new rule to be applied by the system 10 in the generation of all future water damage mitigation estimates, as shown at module 70. The adopted new rule may be stored, for example, in the rules database 50, and the water damage mitigation estimation application 34 will then utilize the new rule when producing water damage mitigation estimates. Additionally, in one or more embodiments, the water damage mitigation estimation application 34 may update previously completed water damage mitigation estimates by applying the new rule to the previously completed and stored estimates.

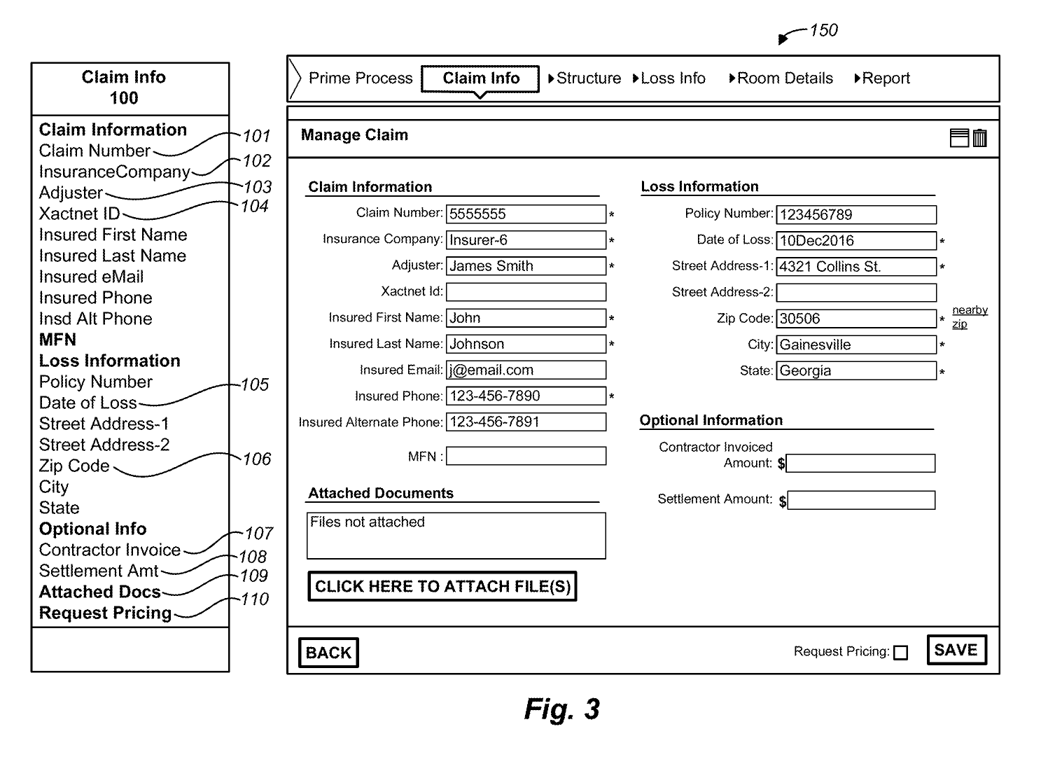

Any of the rules, algorithms or correlations utilized by the water damage mitigation estimation application may be modified or created by the machine learning engine 38 as described herein. For example, the machine learning engine 38 may modify or create new rules related to specific equipment to be used, pricing of equipment and/or labor, date of loss, structural features of properties, and the like. Moreover, water damage mitigation estimates that have been generated by the system 10 may be audited (e.g., by an auditor or adjustor through the water damage mitigation estimation application 34) and the estimate may be adjusted as desired on a case-by-case basis. For example, the auditor may adjust a water damage mitigation estimate to account for one or more factors (e.g., drying took longer or will take longer than estimated due to weather conditions, etc.) that were not sufficiently considered or weighted by the system 10. The adjusted water damage mitigation estimate (which may be stored, for example, in the water damage mitigation estimate database 36) may then be provided to the machine learning engine 38. The machine learning engine 38 uses the adjusted water damage mitigation estimate as training data or input, and the machine learning engine 38 modifies or creates one or more rules for generating water damage mitigation estimates based on the adjustments that were made. FIG. 2B is a flowchart illustrating a water damage mitigation estimate production method 1000, in accordance with one or more embodiments. The water damage mitigation estimate production method 1000 may be performed using the water damage mitigation estimation system 10 shown in FIG. 1. In conjunction with the flowchart of FIG. 2, reference will be made to the various webpages depicted in FIGS. 3-8, which may be accessible to users, for example, through the system 10 of FIG. 1.

At module 1002, the method 1000 begins when water damage mitigation claim information is received (e.g., by the water damage mitigation estimation application 34) from a user (e.g., a claims estimator, claims administrator, claims adjustor, water damage mitigation contractor, or the like). The claim information may be provided by the user upon initiating a new water damage mitigation estimate, or by accessing an already-initiated water damage mitigation estimate. The user may initiate or access the estimate, for example, by using a user computer device 20 to access the water damage mitigation estimation application 34 via the communication network 12. The user may be prompted to provide login credentials or other such authorization information in order to gain access to the water damage mitigation estimation application 34. In addition, or in the alternative, the user may provide such information to gain access to an account associated with the user. The water damage mitigation estimation application 34 may be a web-based application. In one or more embodiments, the water damage mitigation estimation application 34 may include an application program interface (API) which facilitates secure exchange of data to and from one or more third party systems (e.g., one or more computer systems related to water damage claims). Accordingly, the water damage mitigation estimation application 34 may receive certain claim-related data (e.g., insured's name, policy number, address, and the like) from one or more third party systems, which may be utilized as described herein as part of the generation of a water damage mitigation estimate. The water damage mitigation estimate (including, for example, the various line items indicating the work to be performed, equipment to use, estimated costs, etc.) may be provided through the system 10 to the one or more third party systems.

As shown in FIG. 3, the water damage mitigation claim information may be received by user input into a variety of fields provided by a “Claim Info” page 150. The Claim Info block 100, shown to the left of the Claim Info page 150, illustrates some of the fields provided by the Claim Info page 150. For example, the Claim Info page 150 may include fields for entry of a claim number 101, insurance company 102, adjuster 103, third party (e.g., XACTNET) ID 104, date of loss 105, zip code 106, contractor invoice 107, settlement amount 108. Additionally, fields may be provided for attaching documents 109 and to request pricing 110.

The claim number 101 is a system-wide unique identifier when combined with the insurance company 102. That is, each insurance company 102 may have numerous claim numbers 101, each claim number 101 being unique within the insurance company 102 and each claim number 101 assigned to a particular claim with that insurance company 102. The insurance company 102 is associated with Service Level Agreements, and the adjuster 103 is associated with an entity (e.g., the insurance company) and any claims completed, or in progress, by the selected adjuster.

The insurance company 102 field includes a drop-down menu from which the user may select the insurance carrier associated with the damaged property. A variety of insurance carriers may be listed in the drop-down menu, which may be provided, for example, based on insurance information stored in the insurance database 44. The user (e.g., a claims administrator) may receive the insurance carrier information, for example, from the claimant (e.g., the property owner or occupant). Similarly, the adjuster 103 field includes a drop-down menu from which the user may select an adjuster associated with the claim.

The system 10 utilizes several pricing systems provided by various third parties, each of which may have its own third party system ID. The third party ID 104 is thus a unique identifier that enables a user of the particular third party system to access the the system 10, and for use by the system 10 for exchanging data (e.g., via an API transaction) with the third party system.

Other information about the claimant or the insured person may be input by the user from the Claim Info page 150, including the insured's first and last name, email, phone number, insurance policy number, address and so on. Additionally or alternatively, some or all of the information related to the insured person may be automatically provided in the relevant fields of the Claim Info page 150 upon providing other identifying information (e.g., claim number 101 and insurance company 102). For example, the insured's name, address, phone, email and so on may already be associated with a particular claim number, which may be provided, for example, by the insurance carrier and stored in the insurance database 44.

The date of loss 105 field allows the user to enter the date of the event that caused the water damage or the date the water damage was discovered.

Several factors associated with the date of the water damage may be relevant to the mitigation of the water damage, and more particularly, to the determination of an appropriate or even a determined optimal water damage mitigation solution. For example, the time of year or season, weather, humidity and the like can have an impact on water damage mitigation activities (e.g., dehumidification, drying process, etc.). An appropriate, or even determined optimal, mitigation solution for water damage caused in a certain location (e.g., a city, county, zip code, etc.) during a rainy and humid week, for example, may specify a longer drying duration, additional drying capacity and so on, than would normally be recommended under drier and less humid conditions. Accordingly, the date of loss may be provided (along with any other claim information, property location, generated estimate, job report or any other information in the system 10 associated with the date of loss) to the machine learning engine 38 for tracking and refinement of the algorithms used by the system 10 to generate water damage mitigation estimates.

Similarly, the zip code 106 field allows the user to enter the zip code of the water damaged property. The zip code 106 of a water damaged property indicates a geographic location, which may be relevant to the generation of an appropriate or acceptably optimized water damage mitigation solution. The zip code 106 may thus be provided to and/or tracked by the machine learning engine 38. Further, the water damage mitigation estimation application 34 may access pricing information (e.g., as stored in the pricing database 40) based on the zip code 106. The prices of the various task items (including equipment and/or labor) are generally driven by zip code, and the applicable prices included in a water damage mitigation estimate thus vary according to the zip code of the water damaged property. The water damage mitigation estimation application 34 thus generates the water damage mitigation estimate utilizing pricing information that is based at least in part on the zip code 106 that is input by the user. Additionally, the Claim Info page 150 includes a “nearby zip” feature that the user may select, for example, if the entered zip code is rejected (e.g., if the water damage mitigation estimation application 34 is unable to process the entered data because the entered zip code is unavailable or otherwise not associated with pricing, equipment, insurance or other information stored in the databases). When the “nearby zip” feature is selected, the user may be presented with a new webpage, popup screen or web link (e.g., to a United States Postal Service webpage) displaying zip codes that are adjacent to the entered zip code. The user may then select an adjacent zip code, which will be entered into the zip code 106 field, and the water damage mitigation estimation application 34 will generate the water damage mitigation estimate based on pricing and other data that is associated by the system 10 with the adjacent zip code.

The Claim Info page 150 further includes a contractor invoice 107 field and a settlement amount 109 field. These fields are optional and are only applicable, for example, where the water mitigator (e.g., a contractor) has already completed an invoice and/or another amount was settled (e.g., between the contractor and the homeowner and/or between the contractor and the insurance company) prior to entry of the relevant information into the system 10 for generating a water damage mitigation estimate. The contractor invoice 107 and settlement amount 109 may be provided to the machine learning engine 38 for tracking and for refinement of the estimation algorithms utilized by the system 10. For example, if the amount of the contractor invoice 107 and/or the settlement amount 109 end up being significantly different from the estimate produced by the system 10, the actual contractor invoice 107 amount and/or settlement amount 109 may be provided as training data to the machine learning engine 38 in order to further train the machine learning engine 38 and to refine the algorithms and rules utilized by the water mitigation estimation application 34 to generate estimates.

The attached documents 109 field allows the user to attach various documents that may be relevant to the claim, such as drying logs (e.g., logs created or maintained by a contractor to document drying times of a wet wall, or the like), photos (e.g., as may be taken by a contractor on site to document water damage, photos accessible through the map and image database 46, etc.). The request pricing 110 option may be selected by the user, which provides an application program interface (API) that provides various pricing sources by line item (e.g., as may be included in the later generated estimate and report).

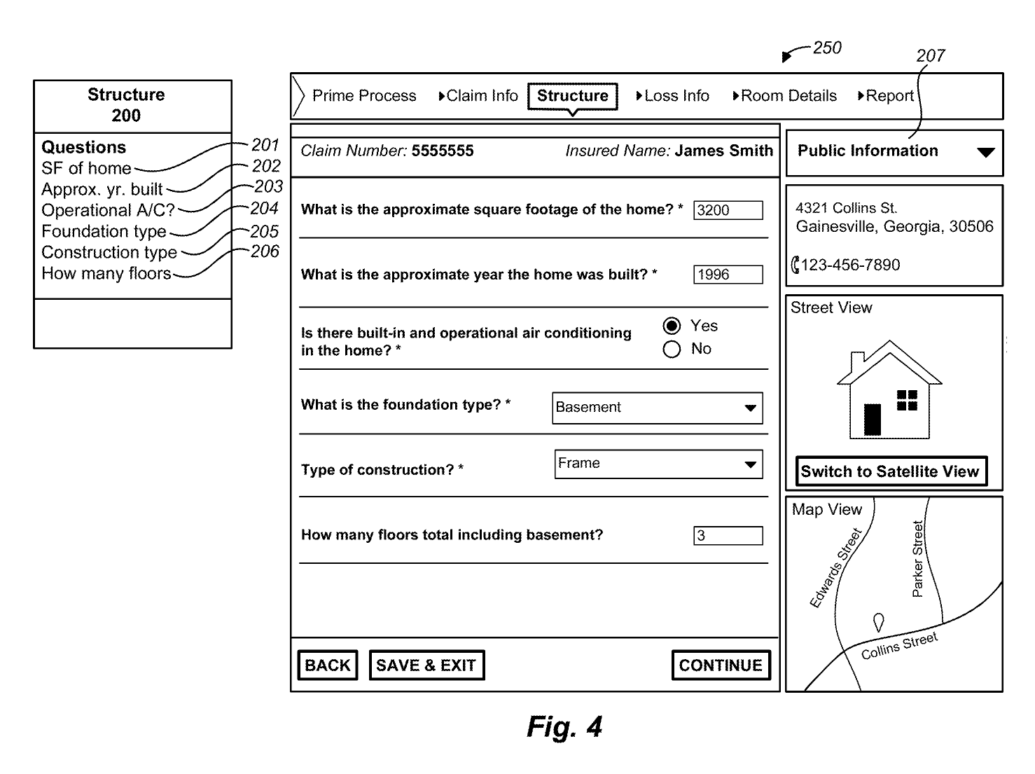

At module 1004, structural information regarding the water damaged property is received from the user. The structural information may be provided by the user through a “Structure” page 250, shown in FIG. 4. The Structure block 200, shown to the left of the Structure page 250, illustrates some of the fields provided by the Structure page 250. For example, the Structure page 250 may include fields for entry of the square footage of the home 201 or property, the approximate year the home was built 202, whether the home has operational air conditioning 203, the foundation type 204, the type of construction 205 and the number of floors 206 in the home. Additionally, the Structure page 250 may display public information 207, which may include any publicly-available information, such as may be obtained from governmental building departments, tax records, public real estate information and the like (e.g., as may be contained in the property database 48), and further may include publicly-available images of real properties (e.g., as may be contained in the map and image database 46).

The square footage of the home 201, which may be provided as input by the user (e.g., as may have been initially provided from a claimant to an insurance company requesting a water damage mitigation estimate, or by inspection of the home by a contractor, etc.), may be compared by the water damage mitigation estimation application 34 to the square footage of the home as may be contained in public information 207.

The approximate year the home was built 202 may indicate possible structural materials used in the construction of the home (e.g., asbestos, types of piping materials used, etc.) that may be relevant to the determination of an appropriate or determined optimal water damage mitigation estimate. Operational air conditioning 203 and the foundation type 204 (e.g., concrete basements, crawl space, etc.) can be factors that affect the drying process or drying time to mitigate water damage. The construction type 205 affects drying based on how capable it is to separate inside and outside temperatures. The number of floors 206 may determine parameters of possible structural involvement in a water damage event (e.g., a burst water pipe on a second floor may cause damage to portions of the first floor). Accordingly, each of these factors (202, 203, 204, 205 and 206) may be provided to the machine learning engine 38 for tracking and refinement of the rules and/or algorithms used by the water damage mitigation estimation application 34 to generate water damage mitigation estimates.

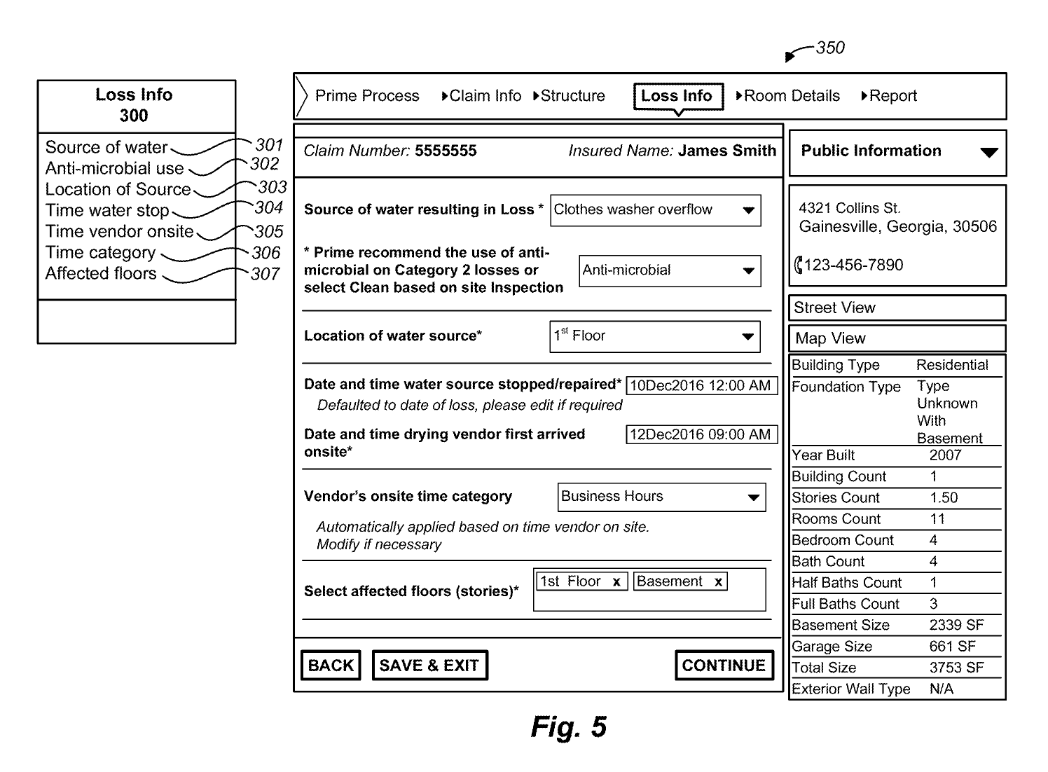

At module 1006, loss information regarding the water damaged property is received from the user. The loss information may be provided by the user through a “Loss Info” page 350, shown in FIG. 5. The Loss Info block 300 illustrates some of the fields provided by the Loss Info page 350. For example, the Loss Info page 350 may include fields for entering the source of water 301 resulting in the loss or damage (e.g., clothes washer overflow, toilet overflow, leaky pipe, etc.), whether an anti-microbial 302 agent will or should be used, the location of the water source 303 (e.g., basement, first floor, etc.), the time/date the water source stopped leaking or was repaired 304, the time/date the vendor arrived onsite 305, the vendor's onsite time category 306 (e.g., business hours, after hours, etc.) and the affected floors 307.

The source of water 301 resulting in the loss is utilized by the system 10 to automatically determine a category of the loss (e.g., water categories 1 to 3), as shown in Table 1 below.

TABLE 1

| Water Source | Water Category |
|---|---|
| Toilet supply line | 1 |
| Refrigerator supply line | 1 |
| Water heater supply line | 1 |
| Toilet tank leak | 1 |
| Toilet overflow | 3 |
| Tub drain leak | 2 |
| Tub or sink overflow | 2 |
| Outside water source | 2 |
| Clothes washer overflow | 2 |
| Rainwater (other than roof) | 2 |
| Clothes washer supply line | 2 |
| Roof leak | 2 |
| Sewer backup | 3 |
| Sink drain backup | 2 |
| Drain backup | 3 |
| Dishwasher overflow | 2 |
| Other | Popup message to |
| | choose the category 1-3 |

The category and class of loss are important factors utilized by the system 10 for determining equipment usage (e.g., dehumidifiers, air movers, etc.) for providing the appropriate or determined optimal water damage mitigation solution. Many of the algorithms and/or rules (e.g., as stored in the rules database 50) utilized by the system 10 are thus associated with or based at least in part on the determined category and class of loss.

For example, the water damage mitigation estimation application 34 determines whether an anti-microbial 302 agent will or should be used based on the category of the loss, which in turn is determined based on the source of water 301 resulting in the loss. Anti-microbial 302 is not needed for category 1 losses. On the other hand, the system 10 will recommend or specify that an anti-microbial agent or a cleaning agent should be used as part of a water mitigation job (and will be included in the estimate) for category 2 and 3 losses.

The location of the water source 303 is also an important factor utilized by the system 10 (e.g., by the algorithms and/or rules stored in the rules database 50) for generating a water mitigation estimate, as the water may travel to downstream or adjacent rooms, and the water damage mitigation estimation application 34 may determine a category of loss for such downstream or adjacent rooms based on the location of the water source 303. The time/date the water source stopped leaking or was repaired 304 indicates how long the source of water 301 was leaking, overflowing, etc., and may further indicate an amount of water that was released during such leaking, overflowing or the like. Similarly, the time/date the vendor arrived onsite 305 provides an indication of a time of exposure to the source of water 301. Each of these factors (i.e., location of the water source 303, time/date the water source stopped 304 and time/date the vendor arrived onsite 305) may be provided to the machine learning engine 38 for tracking and refinement of the algorithms and/or rules used by the water damage mitigation estimation application 34 to generate water damage mitigation estimates.

The affected floors 307 indicates water travel (e.g., with reference or comparison to the identified location of the water source 303), category and a minimum number of drying chambers (e.g., for mitigating the water damage).

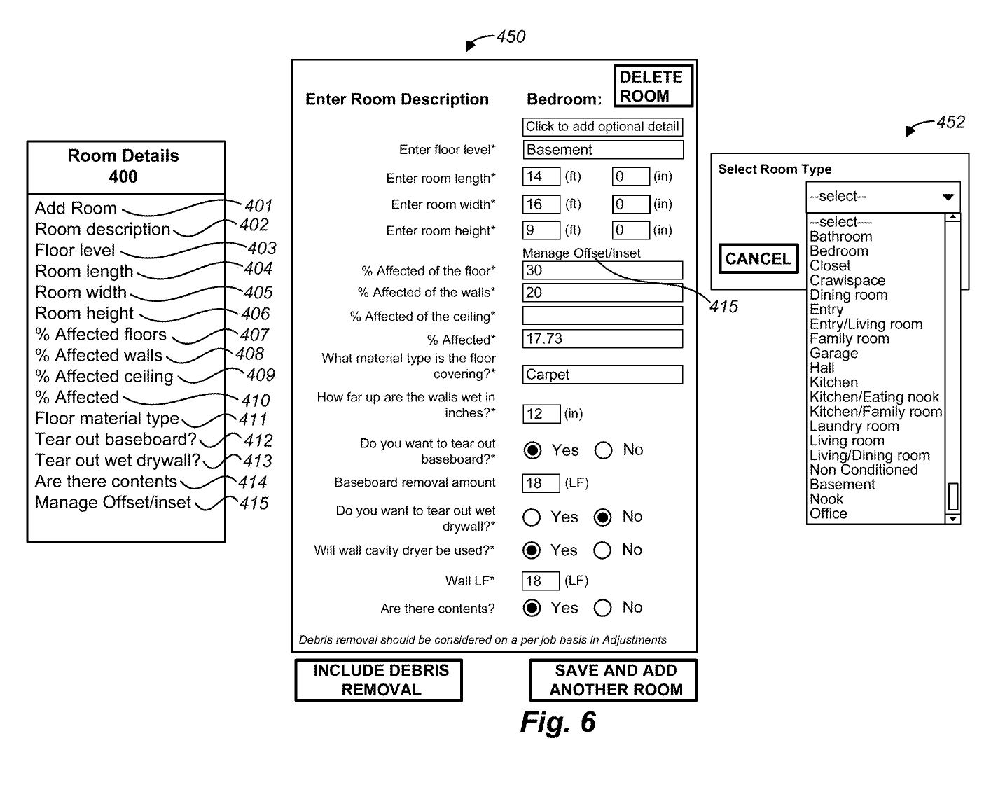

At module 1008, room details regarding the water damaged property are received from the user. The room details may be provided by the user through a “Room Details” page 450, shown in FIG. 6. The Room Details block 400 illustrates some of the fields provided by the Room Details page 450. For example, the Room Details page 450 may include fields for adding a room 401, entering room description 402, floor level 403, room length 404, room width 405, room height 406, % affected floor 407, % affected walls 408, % affected ceiling 409, % affected 410, floor material type 411, whether to tear out a baseboard 412, tear out wet drywall 414, whether there are contents 414 and managing offset/inset 415.

The user may select “Add” or “Save and Add Another Room” from the Room Details page 450, which then provides a room type drop-down menu 452 from which the user may select the room type from among a variety of types of rooms. The user may then optionally add a room description 402 (e.g., “Mary's room”). The floor level 403 field is a drop-down menu that is auto-populated based on the information previously entered in the affected floors 307 field (as entered in the Loss Info page 350 of FIG. 5). For example, if the user indicated in the affected floors 307 field that the garage and first floor were affected, then those floors will be automatically provided in the floor level 403 field of the Room Details page 450.

The user can click on or otherwise select manage offset/inset 415, which provides an additional field for entering offset and inset information regarding the room (e.g., length, width, height of offsets, insets and missing walls). Information input by the user to indicate the room length 404, width 405, height and offset/inset 415 is utilized by the water damage mitigation estimation application 34 to determine square footage of the walls, floors and ceiling in the room, the room volume in cubic feet and the linear feet of the perimeter of the room (including offsets, insets and missing walls).

The % affected floor 407, % affected walls 408 and % affected ceiling 409 fields are input fields to be completed by the user. The % affected 410 is then determined by the water damage mitigation estimation application 34 based on the user provided data in the % affected floor 407, % affected walls 408 and % affected ceiling 409 fields.

The floor material type 411 field may be a drop-down menu providing a plurality of types of flooring materials, including carpet, tile, vinyl, wood and other, from which the user may select one for the particular room. The type of flooring selected by the user is utilized by the water damage mitigation estimation application 34, in conjunction with the source of water 301 (as entered in the Loss Info page 350, shown in FIG. 5), to determine a type of water damage mitigation activity to be undertaken for the floor, and may be included in the completed water damage mitigation estimate and report.

For example, for carpet flooring, the water damage mitigation estimation application 34 will automatically indicate that carpet tear out is to be performed (i.e., as will be indicated in the generated water damage mitigation estimate) for all category 2 or 3 losses (which are determined, as described above, based on the indicated source of water 301). In contrast, only water extraction is to be performed for a room having carpet flooring and only category 1 losses.

If tile flooring is selected from the floor material type 411 field, then the water damage mitigation estimation application 34 will reference the time/date the vendor arrived onsite 305 (as entered in the Loss Info page 350), and will automatically indicate (e.g., in the generated water damage mitigation estimate) that water extraction is to be performed if the vendor arrived onsite or will arrive onsite within some threshold amount of time (e.g., 3 days) since the water source stopped leaking or was repaired (which may be determined by the water damage mitigation estimation application 34, for example, based on entries in the time/date the water source stopped leaking or was repaired 304 and the time/date the vendor arrived onsite 305 fields). If the vendor arrived onsite or will arrive onsite after more than the threshold amount of time (e.g., 3 days), then the water damage mitigation estimation application 34 will not recommend that water extraction be performed, since the tile floor should have naturally dried prior to commencement of work by the vendor (e.g., a water damage mitigator, contractor or the like).

If vinyl flooring is selected from the floor material type 411 field, then the water damage mitigation estimation application 34 will prompt the user (e.g., by a popup message, by displaying another field in the Room Details page 450, or the like) to specify whether some or all of the vinyl flooring will be torn out. If the user indicates that none of the vinyl flooring will be torn out, then the water damage mitigation estimation application 34 will indicate (e.g., in the generated water damage mitigation estimate) that water extraction should be performed if the vendor arrived onsite or will arrive onsite within the threshold amount of time (e.g., 3 days) since the water source stopped leaking or was repaired. Otherwise, the water damage mitigation estimation application 34 will not recommend that water extraction be performed, since the vinyl floor should have naturally dried prior to commencement of work by the vendor.

On the other hand, if the user indicates that some of the vinyl flooring will be torn out, the water damage mitigation estimation application 34 will prompt the user (e.g., by a popup message, by displaying another field in the Room Details page 450, or the like) to enter an amount (e.g., in square feet) of the vinyl floor to be torn out, and a line item is added to the generated water damage mitigation estimate (i.e., a line item indicating that vinyl flooring tear out is to be performed, and indicating the associated estimated price, details of the job and the like).

If wood flooring is selected from the floor material type 411 field, the water damage mitigation estimation application 34 will prompt the user (e.g., by a popup message, by displaying another field in the Room Details page 450, or the like) to specify whether a floor drying system will be used. If the user indicates that a floor drying system will be used for the wood floor, then the water damage mitigation estimation application 34 will indicate (e.g., in the generated water damage mitigation estimate) that floor drying will be performed, determine an appropriate or determined optimal floor drying system that should be used, and the pricing for the floor drying will be included in the final water damage mitigation estimate.

The user may select “Yes” or “No” in the whether to tear out a baseboard 412 field, and if “Yes” is selected, the water damage mitigation estimation application 34 will determine an amount (e.g., in linear feet) of the baseboard to be torn out, which the user can edit.

The Room Details page 450 further includes a field for entry by the user of a height (e.g., in inches) or distance up the walls that is wet. If the user selects “Yes” in the tear out wet drywall 414 field, then the water damage mitigation estimation application 34 will determine an area (e.g., in square feet) of drywall to be removed, based on the height of the walls that is wet (as indicated by user input) and the dimensions (e.g., the perimeter) of the room. The cost associated with removal of the determined amount of drywall is then determined by the water damage mitigation estimation application 34 (e.g., with reference to the pricing database 40 and/or the task and equipment database 42), and the drywall removal and associated costs are included in the water damage mitigation estimate.

Additionally, if the user indicates that wet drywall will be torn out, an additional field may be provided that allows the user to indicate whether the drywall to be torn out is on a wall, ceiling or both. If the walls are indicated as being wet to a height that is above a threshold height (which in various embodiments may be 2″, 4″ or more), then the water damage mitigation estimation application 34 will recommend that one or more wall cavity dryers should be used (which may be selected by the water damage mitigation estimation application 34 from the task and equipment database 42), and the determined wall dryers to use (which may be based on the height or total square footage of the wet walls) will be included in the water damage mitigation estimate, along with an item indicating that holes should be drilled for the wall cavity dryers.

If the user indicates that there are contents 414 in the water damaged room, then the water damage mitigation estimation application 34 will add one or more line items to the generated water damage mitigation estimate for the handling of the contents, based on the size of the room. The Room Details page 450 may further include a selectable button or item that allows the user to indicate whether debris removal will be included as part of the water damage mitigation effort. If debris removal will be included, this is considered by the water damage mitigation estimation application 34 and included as part of the water damage mitigation estimate. Additionally, the Room Details page 450 may display a field for adding dehumidification, particularly for a garage, which may be selected and the water damage mitigation estimation application 34 will determine a dehumidification solution (e.g., number, type, capacity, price or other features of dehumidifiers, as may be stored in the pricing database 40 and/or the task and equipment database 42) for mitigating the water damage, and will include this in the water damage mitigation estimate. The water damage mitigation estimation application 34 differentiates between flood-related causes of loss and water damage caused by other sources of water, as described previously herein. The way the application 34 then applies the relevant algorithms or rules (e.g., flood rules or P&C rules) may be different, for example, for rooms such as crawlspaces and basements. For example, when water damage in a basement is caused by a failed water supply line that supplies hot water to a washing machine, then the water damage may be localized to the area around the washing machine. Conversely, if water damage in the same basement was caused by a flood, then water damage may be suspected throughout the entire basement. In these two cases, different rules may be applied to the water damage mitigation estimate.

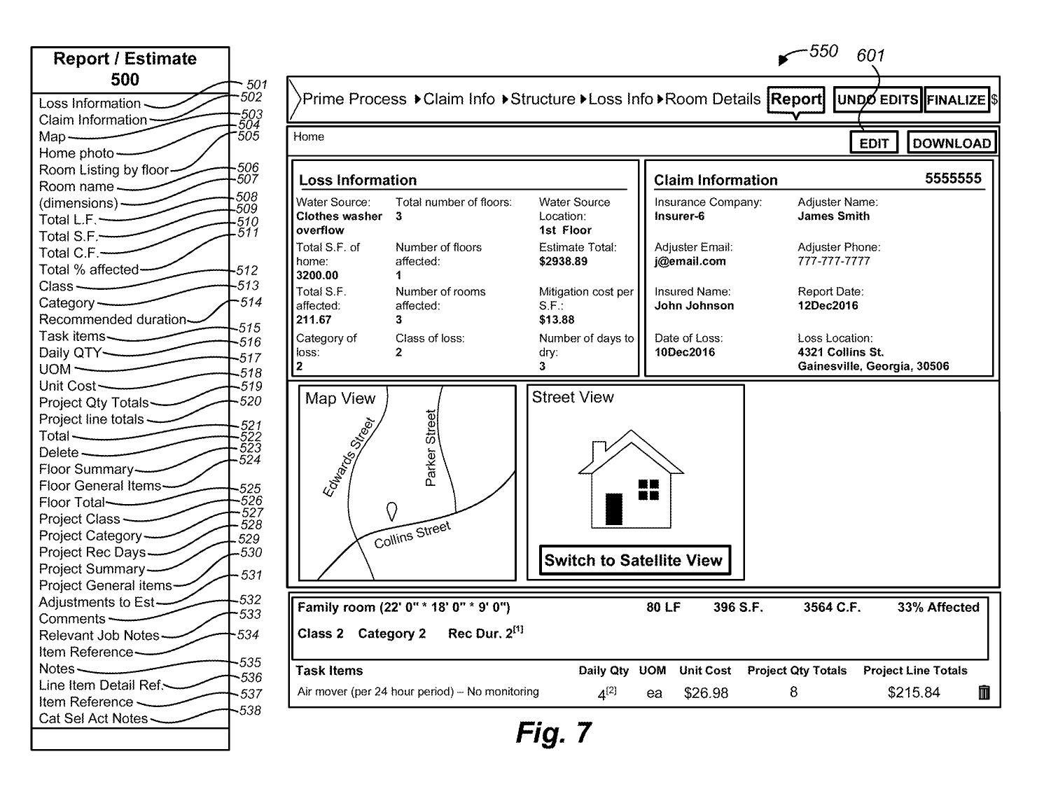

At module 1010, the water damage mitigation estimate is generated and displayed on a “Report” page 550, shown in FIG. 7. The Report/Estimate block 500 illustrates some of the information included in water damage mitigation estimate (as displayed on the Report page 550). For example, the water damage mitigation estimate may include loss information 501, claim information 502, map 503, home photo 504, room listing by floor 505, room name 506, room and/or home dimensions 507, total linear feet 508, total square feet 509, total cubic feet 510, total % affected 511, water damage class 512 and category 513, recommended duration 514 (e.g., duration of drying or other water damage mitigation activities), task items 515, daily quantity 516 (e.g., for each equipment item or task item to be completed), unit of measure (UOM) 517, unit costs 518, project quantity totals 519, project line totals 520, total 521, delete 522, floor summary 523, floor general items 524, floor total 525, project class 526, project category 527, project recommended days 528, project summary 529, project general items 530, adjustments to estimate 531, comments 532, relevant job notes 533, item reference 534, notes 535, line item detail reference 536, item reference 537 and Cat Sel Act Notes 538.

Each of these types of information provided in the water damage mitigation estimate may be determined by the water damage mitigation estimation application 34 based on the various inputs received as claim information 100, structure information 200, loss information 300 and room details 400, and further based on the information stored in the pricing database 40, task and equipment database 42, insurance database 44, map and image database 46, property database 48 and the rules database 50.

The completed water damage mitigation estimate and report is stored in the water damage mitigation estimate database 36, where it may be accessed by a user and may be edited as desired.

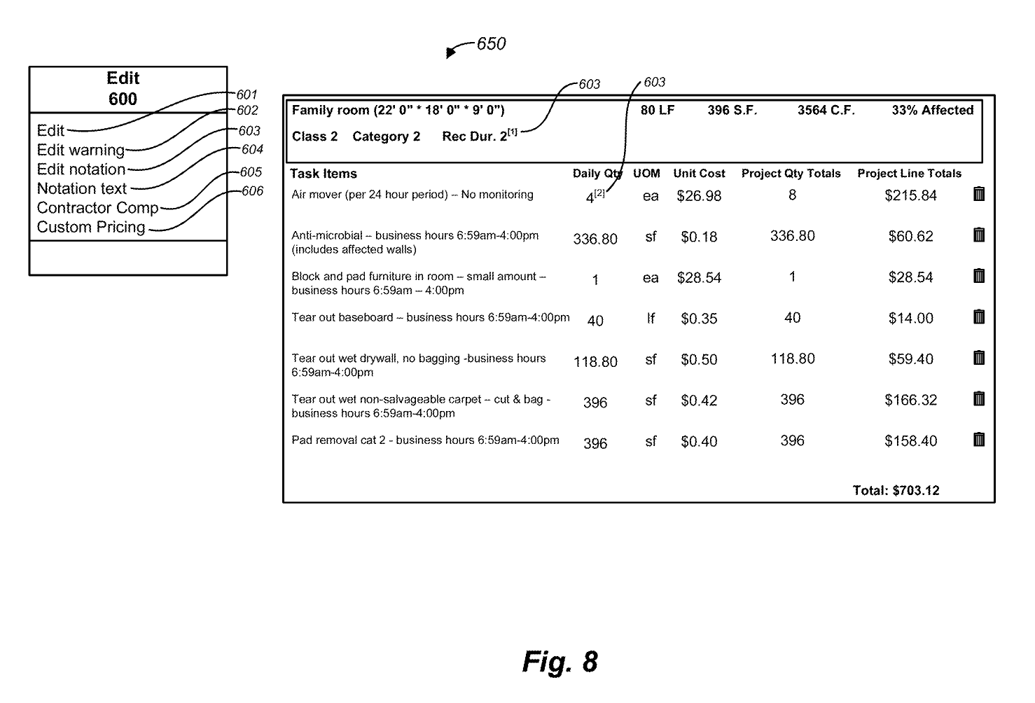

At module 1012, the generated water damage mitigation estimate is displayed and may be edited on a “Edit” page 650, shown in FIG. 8. The Edit page 650 may be accessed by selecting the “edit” button 601 shown on the Report page 550 in FIG. 7.

Some or all of the items provided in, or utilized to generate, the water damage mitigation estimate (including, for example, task items, daily quantity, unit of measure, project quantity totals, project line totals, equipment to use, pricing information and so on) may be edited by a user, such as a claims administrator or adjuster. As shown in the Edit block 600, editing functions provided by the system 10 include the edit button 601, an edit warning 602 that may be provided upon initiating or submitting an edit to a water damage mitigation estimate, edit notation 603, notation text 604, contractor comp 605 and custom pricing 606.

An edit notation 603 is provided and displayed on the water damage mitigation estimate, next to an edited item, to indicate that the item has been edited. As shown in FIG. 8, the edit notation 603 may be a superscript numeral, and the edit notations 603 may be sequentially numbered in order of when the edits were made, from top to bottom of the water damage mitigation estimate, or the like.

The user may select an edit notation 603 (e.g., by clicking on the superscript numeral), and information relating to the edits that were made may be provided and displayed. For example, by clicking on an edit notation 603, the water damage mitigation estimation application 34 may cause notation text 604 to be displayed, which may indicate the original content before editing, the edits that were made to the particular item, the user (e.g., adjuster) who made the edits, and any notes the editing user may have entered (e.g., explanatory notes indicating why the edit was made, etc.).

Once the edits are completed (if there are any), the completed water damage mitigation estimate is stored in the water damage mitigation estimate database 36. An electronic version of the water damage mitigation estimate may be generated and electronically delivered to any interested party, such as an insurance company representative, a water damage mitigator or contractor, or the like. The completed water damage mitigation estimate may thus be used for various purposes, such as for negotiation between the claimant or the insurance company and the water damage mitigator or contractor who will perform the water mitigation.

As illustrated in FIG. 1, user computer devices 20 may be coupled through one or more communication networks 12, 14 to a server computer device 30. In other cases, the user computer devices 20 may operate with features of a server computer device 30, and in such cases, the water damage mitigation estimation application 34 may be contained in a single computing device such as a user computer device 20. For simplicity, embodiments are described herein in the context of server computer device 30, but it is understood that such embodiments could also be carried out within a single user computer device 20.

In addition to the structures expressly illustrated in the non-limiting embodiment of user computer devices 20 and server computer device 30 in FIG. 1, the computing devices also include operative hardware found in a conventional computing apparatus such as one or more processing units (e.g., processor 32), communication port modules, serial and parallel input/output (I/O) modules compliant with various standards and protocols, wired and/or wireless networking modules (e.g., a communications transceiver), multimedia input and output modules, and the like.

A processor (i.e., a processing unit), as used in the present disclosure, refers to one or more processing units individually, shared, or in a group, having one or more processing cores (e.g., execution units), including central processing units (CPUs), digital signal processors (DSPs), microprocessors, micro controllers, state machines, execution units, and the like that execute instructions.

As known by one skilled in the art, the computing devices described herein have one or more memories to store data and processor-executable instructions such contained in or otherwise accessible to the water damage mitigation estimation application 34. In the present disclosure, memory may be used in one configuration or another. The memory may be configured to store data. In the alternative or in addition, the memory may be a non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of the systems, methods, and apparatus described in the present disclosure.

FIG. 1 illustrates portions of a non-limiting embodiment of a user computing device 20, and a server computing device 30. When so arranged as described herein, each computing device may be transformed from a generic and unspecific computing device to a combination device comprising hardware and software configured for a specific and particular purpose. The combination device, when employed as described herein, provides improvements to water damage mitigation estimating technology, insurance technology, water damage mitigation planning technology, and many other technologies. Computing devices 20, 30 include operative hardware found in a conventional computing apparatus such as one or more central processing units (CPUs), volatile and non-volatile memory, serial and parallel input/output (I/O) circuitry compliant with various standards and protocols, and/or wired and/or wireless networking circuitry (e.g., a communications transceiver).

As known by one skilled in the relevant art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory.

The computing devices (e.g., user computer devices 20 and server computer device 30) further include operative software found in conventional computing devices such as an operating system, software drivers to direct operations through the I/O circuitry, networking circuitry, and other peripheral component circuitry. In addition, the computing devices may include operative application software such as network software for communicating with other computing devices, database software for building and maintaining databases, and task management software for distributing the communication and/or operational workload amongst various (CPUs). In some cases, the computing devices used herein are a single hardware machine having the hardware and software listed herein, and in other cases, the computing devices are a networked collection of hardware and software machines working together in a server farm to execute the functions of the water damage mitigation estimation system 10. The conventional hardware and software of the computing devices discussed herein (e.g., user computer devices 20 and server computer device 30) are not shown for simplicity.

As used in the present disclosure, the term “module” refers to an application specific integrated circuit (ASIC), an electronic circuit, a processor and a memory operative to execute one or more software or firmware programs, combinational logic circuitry, or other suitable components (hardware, software, or hardware and software) that provide the functionality described with respect to the module. Several program modules are stored within one or more of the memory structures described herein. The program modules present executable instructions to the one or more processors described herein to carry out the features of the water damage mitigation estimation application 34. FIGS. 2B-8 illustrate a water damage mitigation estimate production method 1000 that may be used by embodiments of the computing devices that implement the water damage mitigation estimation system 10 described herein. In this regard, each described process (or each described module within a described process) may represent a subroutine, segment, or portion of code, which comprises one or more executable instructions for implementing the specified logical function(s). It should also be noted that in some implementations, the functions noted in the process may occur in a different order, may include additional functions, may occur concurrently, and/or may be omitted.

The various embodiments described above can be combined to provide further embodiments. Aspects of the embodiments can be modified, if necessary to employ concepts of the various patents, application and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, by a water damage mitigation estimation application hosted at least partially on a server computer device, insurance claim information regarding a water damaged property, the insurance claim information including information indicating a date of loss, an insurance company and insured information;
receiving, by the water damage mitigation estimation application, structure information regarding the water damaged property, the structure information including information indicating a square footage of the property, a year the property was built, whether the property includes operable air conditioning, a foundation type of the property, a construction type of the property, and a number of floors of the property;
receiving, by the water damage mitigation estimation application, loss information regarding the water damaged property, the loss information including information indicating a water source associated with the water damage, a location of the water source, a time the water source stopped, a time a water damage mitigator arrived on-site at the property, and a number of floors affected by the water damage;
receiving, by the water damage mitigation estimation application, a set of room information for each water damaged room in the property, each member of the set of room information including information indicating a floor level, dimensions, a percent of flooring affected by the water damage, a percent of walls affected by the water damage, a percent of a ceiling affected by the water damage, a floor material type, whether a baseboard will be removed, whether wet drywall will be removed and whether there are contents;
generating, by the water damage mitigation estimation application, a water damage mitigation estimate to mitigate the water damage, the water damage mitigation estimate including equipment-to-mitigate, time-to-mitigate, and price-to-mitigate, the water damage mitigation estimate being generated based on the received structure information, loss information and set of room information; and
outputting the generated water damage mitigation estimate to mitigate the water damage.

2. The method of claim 1, further comprising:
receiving, by a user computer device, the output generated water damage mitigation estimate; and
displaying the generated water damage mitigation estimate on the user computer device.

3. The method of claim 1, wherein the insurance claim information includes information indicating a zip code associated with the water damaged property, the method further including:
determining, based on the zip code associated with the water damaged property, a price book to use; and
generating the water damage mitigation estimate based on the determined price book to use.

4. The method of claim 3, wherein determining a price book to use includes:
receiving the zip code associated with the water damaged property;
determining that the zip code is not associated with an accessible price book to use;
displaying a zip code map including zip code map data indicating zip codes that are adjacent to the received zip code associated with the water damaged property;
receiving a selection of one of the adjacent zip codes; and
determining the price book to use based on the received selection of one of the adjacent zip codes.

5. The method of claim 3, further comprising:
providing the date of loss information to a machine learning engine communicatively coupled with the water damage mitigation estimation application;
providing the zip code to the machine learning engine; and
adjusting, by the machine learning engine, one or more rules for generating the water damage mitigation estimate, based on the date of loss information and the zip code.

6. The method of claim 5, further comprising:
receiving at least one of: invoice information indicating an invoiced amount for mitigating the water damage and settlement amount information indicating a settlement amount for mitigating the water damage;
providing the generated water damage mitigation estimate, and the at least one of the invoiced information and the settlement amount information, to the machine learning engine; and
adjusting, by the machine learning engine, the one or more rules for generating the water damage mitigation estimate, based on the generated water damage mitigation estimate and the at least one of the invoiced information and the settlement amount information.

7. The method of claim 5, further comprising:
providing the location of the water source, the time the water source stopped, and the time a water damage mitigator arrived on-site at the property to the machine learning engine; and
adjusting, by the machine learning engine, the one or more rules for generating the water damage mitigation estimate, based on the location of the water source, the time the water source stopped, and the time a water damage mitigator arrived on-site at the property.

8. The method of claim 1, further comprising:
providing the structure information indicating the year the property was built, whether the property includes operable air conditioning, the foundation type of the property, the construction type of the property and the number of floors of the property to a machine learning engine communicatively coupled with the water damage mitigation estimation application; and
adjusting, by the machine learning engine, one or more rules for generating the water damage mitigation estimate, based on the year the property was built, whether the property includes operable air conditioning, the foundation type of the property, the construction type of the property and the number of floors of the property.

9. The method of claim 1, wherein receiving the structure information includes receiving publicly-available information associated with the water damaged property stored in a property database accessible to the water damage mitigation estimation application.

10. The method of claim 1, further comprising:
determining, by the water damage mitigation estimation application, a category of loss, based on the water source associated with the water damage; and
determining, by the water damage mitigation estimation application, whether an anti-microbial agent should be used to mitigate the water damage, based on the determined category of loss.

11. The method of claim 10, wherein generating the water damage mitigation estimate includes generating the water damage mitigation estimate based on the determined category of loss.

12. The method of claim 1, further comprising:
determining, by the water damage mitigation estimation application, a difference in time between the time the water source stopped and the time a water damage mitigator arrived on-site at the property;
comparing the determined difference in time with a threshold time difference; and
determining, by the water damage mitigation estimation application, whether water extraction should be performed and whether flooring should be removed, based on the determined difference in time and the floor material type.

13. The method of claim 12, further comprising:
determining, by the water damage mitigation estimation application, a floor drying solution for mitigating the water damage, based on the floor material type.

14. The method of claim 1, further comprising:
determining, by the water damage mitigation estimation application, an area of the drywall to be removed, based on a height of the drywall that is wet;
comparing the height of the drywall that is wet with a threshold height; and
determining one or more wall cavity dryers to be used to mitigate the water damage if the height of the drywall that is wet exceeds the threshold height.

15. A water damage mitigation estimation system, comprising:
a first computing device;
a water damage mitigation estimate database arranged to store electronic water damage mitigation estimates associated with respective water damaged structures; and
a water damage mitigation estimation application, stored at least partially on a second computing device having a processor, the water damage mitigation estimation application having access to a pricing database, a task and equipment database, an insurance database, a map and image database, a property database and a rules database, the water damage mitigation estimation application being configured to:
receive insurance claim information regarding a water damaged property, the insurance claim information including information indicating a date of loss, an insurance company and insured information, the insurance claim information being received from at least one of the first computer device and the insurance database;
receive structure information regarding the water damaged property, the structure information including information indicating a square footage of the property, a year the property was built, whether the property includes operable air conditioning, a foundation type of the property, a construction type of the property, and a number of floors of the property, the structure information being received from at least one of the first computer device and the property database;
receive loss information regarding the water damaged property, the loss information including information indicating a water source associated with the water damage, a location of the water source, a time the water source stopped, a time a water damage mitigator arrived on-site at the property, and a number of floors affected by the water damage, the loss information being received from the first computer device;
receive a set of room information for each water damaged room in the property, each member of the set of room information including information indicating a floor level, dimensions, a percent of flooring affected by the water damage, a percent of walls affected by the water damage, a percent of a ceiling affected by the water damage, a floor material type, whether a baseboard will be removed, whether wet drywall will be removed and whether there are contents, the set of room information being received from the first computer device;
generate a water damage mitigation estimate to mitigate the water damage, the water damage mitigation estimate including equipment-to-mitigate, time-to-mitigate, and price-to-mitigate, the water damage mitigation estimate being generated based on the received structure information, loss information and set of room information, the water damage mitigation estimate being generated based on the received insurance claim information, structure information, loss information, set of room information and rules stored in the rules database; and
output the generated water damage mitigation estimate to mitigate the water damage.

16. The water damage mitigation estimation system of claim 15, further comprising a machine learning engine communicatively coupled to the water damage mitigation estimation application and the rules database, the machine learning engine being configured to:
receive at least one of: invoice information indicating an invoiced amount for mitigating the water damage and settlement amount information indicating a settlement amount for mitigating the water damage; and
adjust one or more rules stored in the rules database for generating the water damage mitigation estimate, based on the generated water damage mitigation estimate and the at least one of the invoiced information and the settlement amount information.

17. The water damage mitigation estimation system of claim 15, the water damage mitigation estimation application being further configured to:
determine a category of loss, based on the water source associated with the water damage; and
determine whether an anti-microbial agent should be used to mitigate the water damage, based on the determined category of loss.

18. The water damage mitigation estimation system of claim 15, the water damage mitigation estimation application being further configured to:
determine a total percentage affected for each water damaged room, based on the percent of flooring affected by the water damage, the percent of walls affected by the water damage and the percent of the ceiling affected by the water damage;
determine a class of loss, based on the determined total percentage affected; and
generate the water damage mitigation estimate based on the determined class of loss.

19. The water damage mitigation estimation system of claim 15, the water damage mitigation estimation application being further configured to:
determine a difference in time between the time the water source stopped and the time a water damage mitigator arrived on-site at the property;
compare the determined difference in time with a threshold time difference; and
determine whether water extraction should be performed and whether flooring should be removed, based on the determined difference in time and the floor material type.

20. A non-transitory computer program product having stored thereon a set of computer instructions, the computer instructions configured to carry out a method comprising:
receiving, by a water damage mitigation estimation application hosted at least partially on a server computer device, insurance claim information regarding a water damaged property, the insurance claim information including information indicating a date of loss, an insurance company and insured information;
receiving, by the water damage mitigation estimation application, structure information regarding the water damaged property, the structure information including information indicating a square footage of the property, a year the property was built, whether the property includes operable air conditioning, a foundation type of the property, a construction type of the property, and a number of floors of the property;
receiving, by the water damage mitigation estimation application, loss information regarding the water damaged property, the loss information including information indicating a water source associated with the water damage, a location of the water source, a time the water source stopped, a time a water damage mitigator arrived on-site at the property, and a number of floors affected by the water damage;
receiving, by the water damage mitigation estimation application, a set of room information for each water damaged room in the property, each member of the set of room information including information indicating a floor level, dimensions, a percent of flooring affected by the water damage, a percent of walls affected by the water damage, a percent of a ceiling affected by the water damage, a floor material type, whether a baseboard will be removed, whether wet drywall will be removed and whether there are contents;
generating, by the water damage mitigation estimation application, a water damage mitigation estimate to mitigate the water damage, the water damage mitigation estimate including equipment-to-mitigate, time-to-mitigate, and price-to-mitigate, the water damage mitigation estimate being generated based on the received structure information, loss information and set of room information; and
outputting the generated water damage mitigation estimate to mitigate the water damage.

21. The non-transitory computer program product of claim 19, the computer instructions configured to carry out a method further comprising:
receiving at least one of: invoice information indicating an invoiced amount for mitigating the water damage and settlement amount information indicating a settlement amount for mitigating the water damage;
providing the generated water damage mitigation estimate, and the at least one of the invoiced information and the settlement amount information, to a machine learning engine; and
adjusting, by the machine learning engine, one or more rules for generating the water damage mitigation estimate, based on the generated water damage mitigation estimate and the at least one of the invoiced information and the settlement amount information.
